(19) United States
(12) Patent Application Publication
(10) Pub. No.: US 2023/0231346 A1
(43) Pub. Date: Jul. 20, 2023

(54) Electric Connection Assembly, Control Cabinet And Robot System

(71) Applicant: ABB Schweiz AG, Baden (CH)

(72) Inventor: Marcus Wadstein, Västerås (SE)

(21) Appl. No.: 17/998,149

(22) PCT Filed: May 13, 2020
(86) PCT No.: PCT/EP2020/063286

§ 371 Date: Nov. 7, 2022

(51) Int. Cl. H01R 13/74; H01R 9/26; H01R 13/6586; H01R 13/53

(52) U.S. Cl. CPC H01R 13/74; H01R 9/26; H01R 13/53; H01R 13/6586

(57) ABSTRACT

An electric connection assembly for a control cabinet, the electric connection assembly including a base body having an opening structure; an electric connector for connection to a plurality of external electric cables, the connector being connected to the base body and aligned with the opening structure; and a support structure including a rail for supporting a plurality of electric connection terminals, the support structure being connected to the base body opposite to the connector. A control cabinet for an industrial robot including an electric connection assembly is also provided. A robot system including an industrial robot, a control cabinet and a plurality of external electric cables connected to the industrial robot and to the connector is also provided.

### TECHNICAL FIELD

The present disclosure generally relates to an electric connection assembly. In particular, an electric connection assembly for a control cabinet, a control cabinet for an industrial robot, and a robot system comprising an industrial robot and a control cabinet, are provided.

### BACKGROUND

In some robot systems, electric cables are routed between an industrial robot and a control cabinet. The electric cables may be led to a dresspack on the industrial robot. The dresspack typically comprises a plurality of cables and hoses grouped together. One or more customer connection points may be provided inside the control cabinet to which a customer can electrically connect auxiliary equipment. One example of such auxiliary equipment is a control unit for controlling a particular end effector that the customer has connected to the industrial robot.

In order to provide one or more customer connection points in the control cabinet, some control cabinets comprise electric cables routed from a connector in a customer connection panel, throughout the control cabinet, across hinges of a cabinet door and to the cabinet door. By routing the electric cables to the door of the control cabinet, the cabling becomes long. This increases a risk of electrical disturbance and complicates installation. Moreover, the increased cabling occupies space inside the control cabinet and increases weight of the control cabinet. Each intermediate connection point also decreases signal quality. Furthermore, movements of the door risk to damage the electric cables.

DE 19716917 C1 discloses a mounting device allowing a contact block to be secured to a carrier rail via a base plate secured across the width of the latter, provided with a pair of spaced carriers for the contact block. The contact block is supported at a given distance above the base plate by the spaced carriers, with a contact block seating between at least one of the carriers and the contact block, allowing it to pivot relative to the base plate.

### SUMMARY

One object of the present disclosure is to provide an electric connection assembly for a control cabinet, which electric connection assembly has a compact design.

A further object of the present disclosure is to provide an electric connection assembly for a control cabinet, which electric connection assembly has a simple design.

A still further object of the present disclosure is to provide an electric connection assembly for a control cabinet, which electric connection assembly is cost-effective.

A still further object of the present disclosure is to provide an electric connection assembly for a control cabinet, which electric connection assembly enables simple and fast installation.

A still further object of the present disclosure is to provide an electric connection assembly for a control cabinet, which electric connection assembly enables automized installation.

A still further object of the present disclosure is to provide an electric connection assembly for a control cabinet, which electric connection assembly can be both delivered and connected to a control cabinet in an assembled state.

A still further object of the present disclosure is to provide an electric connection assembly for a control cabinet, which electric connection assembly enables electric cable routing to be reduced.

A still further object of the present disclosure is to provide an electric connection assembly for a control cabinet, which electric connection assembly enables a number of electric connection points to be reduced.

A still further object of the present disclosure is to provide an electric connection assembly for a control cabinet, which electric connection assembly has a small size.

A still further object of the present disclosure is to provide an electric connection assembly for a control cabinet, which electric connection assembly has a low weight.

A still further object of the present disclosure is to provide an electric connection assembly for a control cabinet, which electric connection assembly solves several or all of the foregoing objects in combination.

A still further object of the present disclosure is to provide a control cabinet for an industrial robot, which control cabinet solves one, several or all of the foregoing objects.

A still further object of the present disclosure is to provide a robot system comprising an industrial robot and a control cabinet, which robot system solves one, several or all of the foregoing objects.

According to one aspect, there is provided an electric connection assembly for a control cabinet, the electric connection assembly comprising a base body having an opening structure; an electric connector for connection to a plurality of external electric cables, the connector being connected to the base body and aligned with the opening structure; and a support structure comprising a rail for supporting a plurality of electric connection terminals, the support structure being connected to the base body opposite to the connector.

By means of the support structure, the connection terminals can be positioned close to the connector. In this way, customer connection points in the connection terminals can be moved closer to the external electric cables with very low obstruction of the interior of the control cabinet. The electric connection assembly is thereby compact, and the customer can connect an internal electric cable close to the connector regardless of the type of external electric cables. The compactness of the electric connection assembly further contributes a reduced weight and size of the control cabinet.

The electric connection assembly may be preassembled and modular, i.e. formed as a single unit. That is, the electric connection assembly may be configured to be installed in the control cabinet in an assembled state. This enables simple installation of the electric connection assembly with few steps. The preassembled electric connection assembly enables the installation to be automized. The entire electric connection assembly may be connected to a wall of the control cabinet by only fastening the base body to the wall, e.g. by means of screws or other fasteners or by means of adhesive.

Each of the connector and the support structure may be fixedly connected to the base body, e.g. by means of screws or other fasteners or by means of adhesive. Moreover, each of the connector and the support structure may be directly connected to the base body such that the base body is positioned between the connector and the support structure.

The opening structure may comprise a single opening or a plurality of openings. In any case, the one or more openings may extend through the base body. In case the opening structure comprises a single opening, the opening may have a quadrangular shape, such as a rectangular shape. Alternatively, or in addition, the opening structure may be substantially centered, or centered, in the base body.

The rail may be straight or substantially straight. The rail may have a uniform cross-sectional profile along its length.

The connector may be of different types. For example, an interface of the connector may vary for different electric connection assemblies to connect to different sets of external electric cables. The external electric cables are external with respect to the control cabinet when the electric connection assembly is installed in the control cabinet.

The electric connection assembly may be configured to be connected to a wall having an interior side, an exterior side and a through hole. In this case, the base body may be connected to the interior side, and the connector may protrude through the through hole. The wall may be of sheet metal. The wall may be a customer connection panel in the control cabinet.

The support structure may comprise one or more legs distancing the rail from the opening structure. In this case, the one or more legs may be connected to the base body. The distancing may be such that enough space for intermediate electric cables between the connector and the connection terminals is provided.

Each leg may be substantially perpendicular to, or perpendicular to, the rail. Alternatively, or in addition, each leg may have a length that is 10% to 50% of a length of the rail.

The support structure may comprise two legs. In this case, the rail may be provided between the legs, and the legs may be connected to the base body on opposite sides of the opening structure.

The rail may be a DIN rail. The abbreviation DIN refers to “Deutsches Institut für Normung” in Germany. Alternatively, or in addition, the rail may be a top hat rail.

The support structure may be made from a single sheet of material. The support structure may be produced by bending a flat single sheet of material. The single sheet of material may be sheet metal. Both the rail and the one or more legs of the support structure may originate from the same single sheet of material.

The base body may be a plate. The base body may be made of sheet metal. Alternatively, or in addition, the base body may be quadrangular, such as rectangular or square.

The connector may be a heavy-duty connector. The connector may have a standardized interface. The connector may have a quadrangular shape, such as a rectangular shape.

The electric connection assembly may further comprise the plurality of connection terminals. In this case, each connection terminal may be connected to the rail and may be configured to be electrically connected to an internal electric cable. Each connection terminal thereby provides a customer connection point. When the connection terminals are connected to the rail, the support structure may be positioned between the base body and the connection terminals. The internal electric cables are internal with respect to the control cabinet when the electric connection assembly is installed in the control cabinet.

The connection terminals may be detachably connectable to the rail, for example by means of a snap-fit. Alternatively, or in addition, the electric connection assembly may further comprise the plurality of internal electric cables.

The electric connection assembly may further comprise one or more intermediate electric cables. In this case, each intermediate electric cable may be electrically connected to the connector and to a unique connection terminal.

The electric connection assembly may further comprise a terminal block. In this case, the connection terminals may be provided in the terminal block. The terminal block may be a double deck terminal block. Alternatively, or in addition, the terminal block may comprise two end plates such that the connection terminals are provided between the end plates.

Each connection terminal may be a push-in terminal. The push-in terminals enable toolless connection of the internal electric cables to the connection terminals. The internal electric cables may be stripped and pushed into the connection terminal to establish a mechanical and electrical connection.

The electric connection assembly may further comprise a plurality of electrically conductive shielding elements. In this case, each shielding element may be electrically connected, and each shielding element may be connectable to a shield of an internal electric cable. By means of the one or more shielding elements, signal integrity can be maintained.

According to a further aspect, there is provided a control cabinet for an industrial robot, the control cabinet comprising an electric connection assembly according to the present disclosure. The control cabinet may further comprise a robot controller for controlling operations of the industrial robot.

The control cabinet may comprise a wall having an interior side, an exterior side and a through hole. In this case, the base body may be connected to the interior side, and the connector may protrude through the through hole. The electric connection assembly may thus be mounted to the wall of the control cabinet from the inside, i.e. rear mounted. This enables the through hole in the wall to only be as large as the connector. Moreover, in this way, cabling does not have to be led through the through hole.

Optionally, a seal may be provided between the base body and the wall for sealing the through hole. Such seal may for example be connected to the base body around the connector, or to the wall around the through hole, prior to mounting the electric connection assembly to the wall.

According to a further aspect, there is provided a robot system comprising an industrial robot, a control cabinet according to the present disclosure, and a plurality of external electric cables connected to the industrial robot and to the connector. The external electric cables may be at least partly arranged in a dresspack. Alternatively, the external electric cables may be connected to a dresspack.

### BRIEF DESCRIPTION OF THE DRAWINGS

Further details, advantages and aspects of the present disclosure will become apparent from the following embodiments taken in conjunction with the drawings, wherein:

FIG. 1: schematically represents a side view of a robot system comprising an industrial robot, a control cabinet and an electric connection assembly;

FIG. 2: schematically represents a perspective top view of the electric connection assembly;

FIG. 3: schematically represents a perspective bottom view of the electric connection assembly;

FIG. 4: schematically represents a single sheet of material;

FIG. 5: schematically represents a perspective top view of the electric connection assembly and a wall of the control cabinet prior to installation;

FIG. 6: schematically represents a perspective top view of the electric connection assembly installed in the wall;

FIG. 7: schematically represents a further perspective top view of the electric connection assembly installed in the wall; and

FIG. 8: schematically represents a perspective bottom view of the electric connection assembly installed in the wall.

### DETAILED DESCRIPTION

In the following, an electric connection assembly for a control cabinet, a control cabinet for an industrial robot, and a robot system comprising an industrial robot and a control cabinet, will be described. The same or similar reference numerals will be used to denote the same or similar structural features.

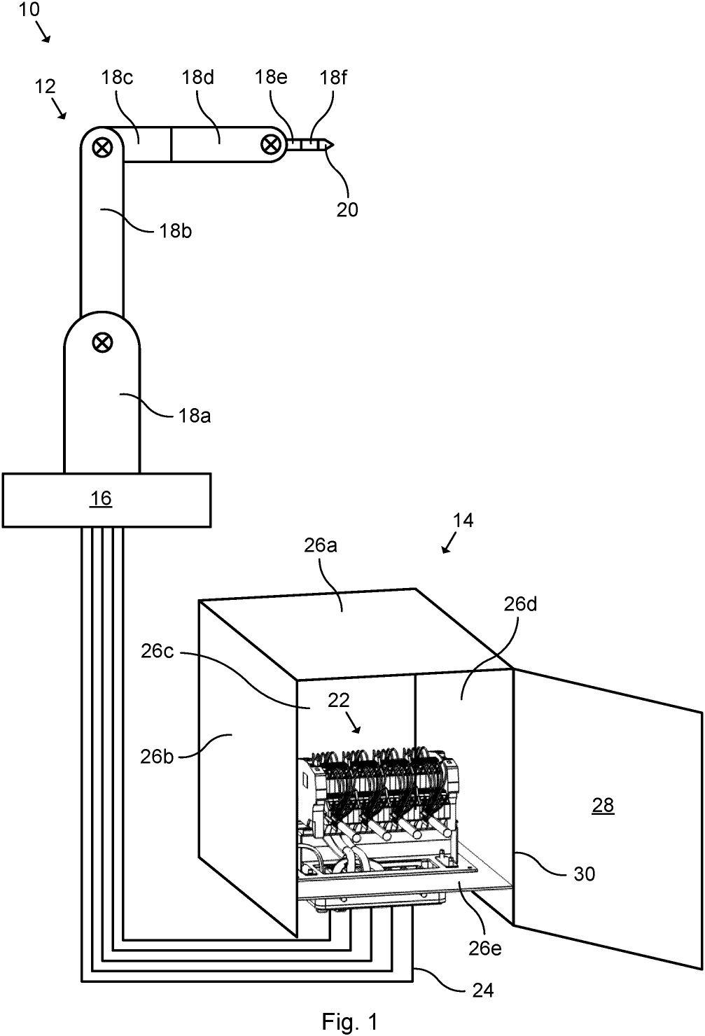

FIG. 1 schematically represents a side view of a robot system 10. The robot system 10 comprises an industrial robot 12 and a control cabinet 14. The industrial robot 12 of this specific example comprises a base 16, a first link 18a rotatable relative to the base 16 at a first joint, a second link 18b rotatable relative to the first link 18a at a second joint, a third link 18c rotatable relative to the second link 18b at a third joint, a fourth link 18d rotatable relative to the third link 18c at a fourth joint, a fifth link 18e rotatable relative to the fourth link 18d at a fifth joint, a sixth link 18f rotatable relative to the fifth link 18e at a sixth joint. The industrial robot 12 of this example thus comprises six degrees of freedom. The industrial robot 12 has been customized by attachment of a particular end effector 20 to the sixth link 18f.

The control cabinet 14 comprises an electric connection assembly 22. The electric connection assembly 22 is installed inside the control cabinet 14. The control cabinet 14 further comprises a robot controller (not shown) for controlling the industrial robot 12.

The robot system 10 further comprises a plurality of external electric cables 24. The external electric cables 24 are connected between the industrial robot 12 and the electric connection assembly 22. The robot controller may be connected to the industrial robot 12 via the electric connection assembly 22 and the external electric cables 24.

The control cabinet 14 of this specific example comprises a top wall 26a, a first side wall 26b, a rear wall 26c, a second side wall 26d and a bottom wall 26e. The control cabinet 14 further comprises a door 28. The door 28 is connected to the second side wall 26d by means of a hinge 30. Each wall 26a-26e may also be referred to with reference numeral “26”.

As shown in FIG. 1, the electric connection assembly 22 is installed in the bottom wall 26e. The electric connection assembly 22 may however be installed in any of the walls 26a-26e of the control cabinet 14.

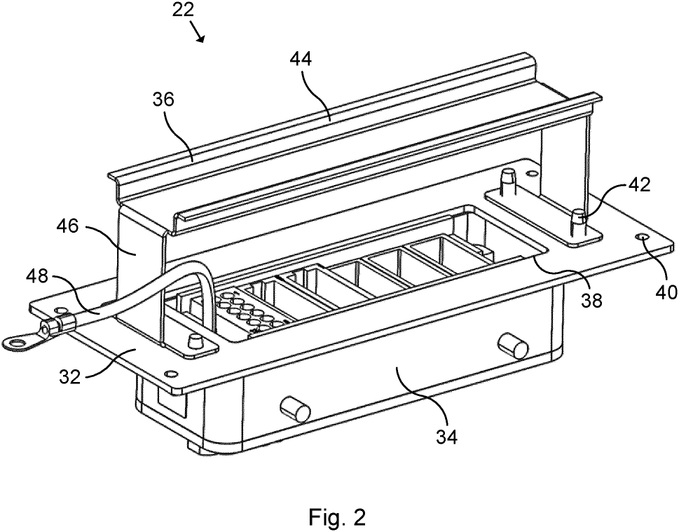

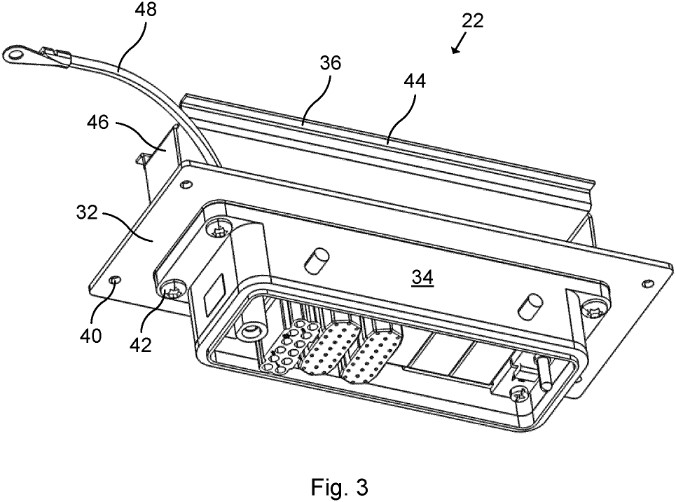

FIG. 2 schematically represents a perspective top view of the electric connection assembly 22, and FIG. 3 schematically represents a perspective bottom view of the electric connection assembly 22. With collective reference to FIGS. 2 and 3, the electric connection assembly 22 comprises a mounting plate 32, an electric connector 34 and a support structure 36. The mounting plate 32 is one example of a base body as described herein.

The mounting plate 32 comprises an opening 38. The opening 38 extends through the mounting plate 32. The opening 38 is one example of an opening structure as described herein. The mounting plate 32 of this specific example is a rectangular plate made of sheet metal. The opening 38 is also rectangular and centered in the mounting plate 32.

The mounting plate 32 further comprises a plurality of plate mounting holes 40. In this example, the mounting plate 32 comprises four plate mounting holes 40, one at each corner of the mounting plate 32.

The connector 34 is rigidly connected to the mounting plate 32 and aligned with the opening 38. In this example, the connector 34 is connected to the mounting plate 32 by means of four screws 42. The external electric cables 24 (see FIG. 1) are connectable to the connector 34. The connector 34 of this example is a heavy-duty connector having a standardized interface.

The support structure 36 comprises a rail 44, here exemplified as a top hat DIN rail having a uniform cross-sectional profile. The rail 44 is configured to support a plurality of electric connection terminals.

The support structure 36 further comprises two legs 46. As shown in FIG. 2, each leg 46 is connected to the mounting plate 32 by means of the screws 42. The support structure 36 is thereby rigidly connected to the mounting plate 32 on an opposite side with respect to the connector 34. That is, the mounting plate 32 is arranged between the connector 34 and the support structure 36.

Each leg 46 is perpendicular to the rail 44. The legs 46 establish a distance between the opening 38 and the rail 44. The legs 46 are provided on opposite sides of the opening 38. In this way, the rail 44 bridges over the opening 38.

The electric connection assembly 22 further comprises a grounding cable 48. The grounding cable 48 is connected to the connector 34.

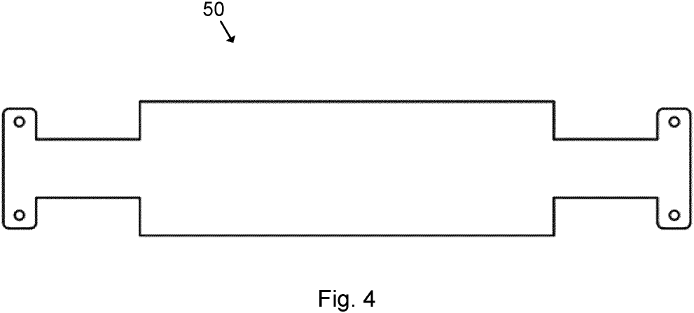

FIG. 4 schematically represents a single sheet 50 of material, here exemplified as a metal sheet. The support structure 36 is produced from such sheet 50. By bending the sheet 50, the legs 46 and the rail 44 having the top hat shape can be formed. An end of each leg 46 can further be bent to provide an attachment section for the screws 42.

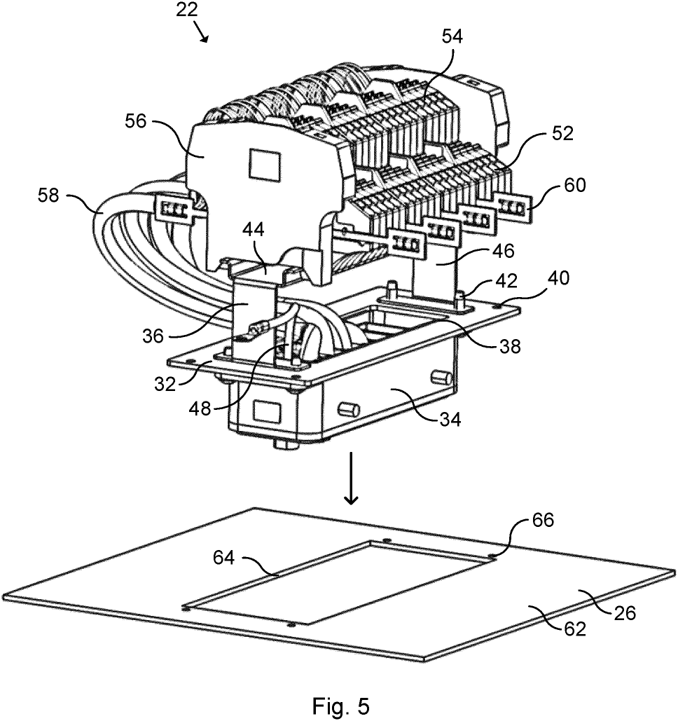

FIG. 5 schematically represents a perspective top view of the electric connection assembly 22 and a wall 26 of the control cabinet 14 prior to installation of the electric connection assembly 22 to the control cabinet 14.

The electric connection assembly 22 in FIG. 5 further comprises a plurality of connection terminals 52. The electric connection assembly 22 further comprises a terminal block 54, here exemplified as a double deck terminal block. The terminal block 54 comprises two end plates 56 and the connection terminals 52 provided between the end plates 56.

The terminal block 54 is detachably connected to the rail 44 by means of a snap-fit. The terminal block 54 is connected on top of the rail 44 such that the rail 44 is positioned between the mounting plate 32 and the terminal block 54.

Each connection terminal 52 is configured to be electrically connected to an internal electric cable. Each connection terminal 52 thereby provides a customer connection point. In this example, the connection terminals 52 are push-in terminals. The terminal block 54 comprises a customer side and a rear side, opposite to the customer side.

The electric connection assembly 22 in FIG. 5 further comprises a plurality of intermediate electric cables 58. Each intermediate electric cable 58 is electrically connected to the connector 34 and to a respective connection terminal 52. The intermediate electric cables 58 are connected to the rear side of the terminal block 54. The distancing between the rail 44 and the connector 34 due to the legs 46 provides enough space for connection of the intermediate electric cables 58.

The electric connection assembly 22 in FIG. 5 further comprises a plurality of electrically conductive shielding elements 60. The shielding elements 60 are connected to the terminal block 54. In this specific example, four shielding elements 60 are provided on the customer side of the terminal block 54 and four shielding elements 60 are provided on the rear side of the terminal block 54. Each shielding element 60 on the rear side is connected to a shield (not denoted) of a respective intermediate electric cable 58.

The wall 26 in FIG. 5 constitutes a customer connection panel and comprises an interior side 62, an exterior side (not visible) and a through hole 64. In this example, the wall 26 is of sheet metal. The through hole 64 has a rectangular shape corresponding to the shape of the connector 34. The wall 26 further comprises four wall mounting holes 66. Each wall mounting hole 66 is associated with a unique plate mounting hole 40.

As shown in FIG. 5, the electric connection assembly 22 is a compact unit ready for installation in the wall 26. The support structure 36 positions the connection terminals 52 close to the connector 34. The electric connection assembly 22 may be preassembled according to FIG. 5 prior to connection to the wall 26.

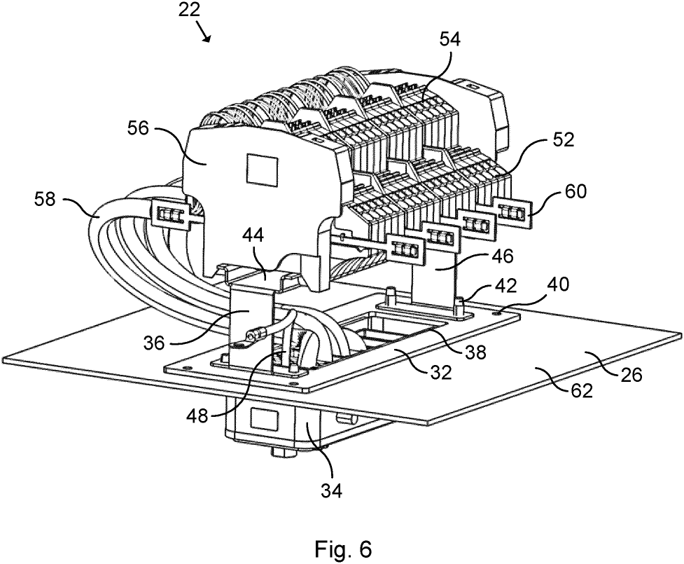

FIG. 6 schematically represents a perspective top view of the electric connection assembly 22 installed in the wall 26. When delivering the robot system 10 to a customer, it may not always be known what type of equipment the customer wants to add to the robot system 10. The connection terminals 52 provide a plurality of customer connection points to which the customer can connect various auxiliary equipment. The connection terminals 52 may for example comprise 24 V connections, analog connections, and digital connections.

The electric connection assembly 22 has been moved downwards (in FIGS. 5 and 6) until the connector 34 enters the through hole 64 and the mounting plate 32 mates with the interior side 62 of the wall 26. Each plate mounting hole 40 is thereby aligned with an associated wall mounting hole 66. As shown in FIG. 6, the connector 34 protrudes through the through hole 64.

A fastener (not shown), such as a screw or bolt, may be inserted through each pair of plate mounting hole 40 and wall mounting hole 66 to secure the electric connection assembly 22 to the wall 26. The entire electric connection assembly 22 is thereby connected to the wall 26 by only fastening the mounting plate 32 to the wall 26.

Since the electric connection assembly 22 is installed in the control cabinet 14 in an assembled state, the installation requires very few steps. This makes the installation simple and opens up for the possibility to automize the installation of the electric connection assembly 22 to the control cabinet 14. For example, no cables need to be mounted or have to be pulled through the through hole 64. The grounding cable 48 may be connected to the wall 26. The electric connection assembly 22 may be automatically installed in the control cabinet 14 by means of a robot.

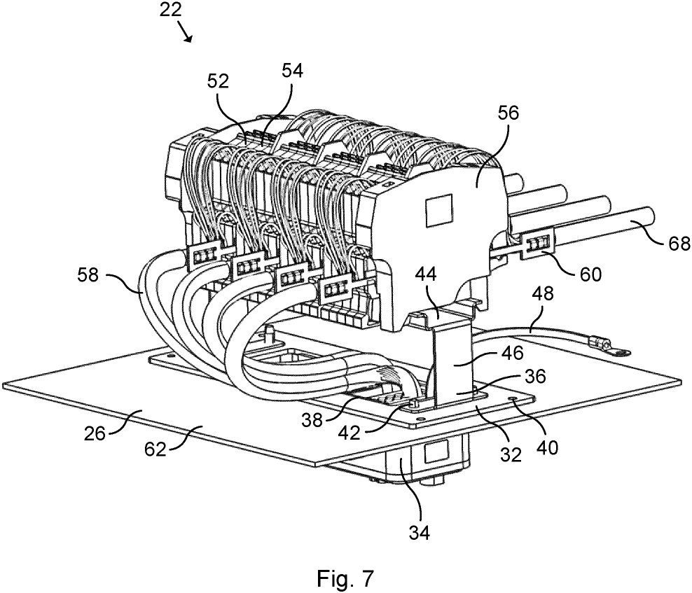

FIG. 7 schematically represents a further perspective top view of the electric connection assembly 22 installed in the wall 26. The electric connection assembly 22 in FIG. 7 further comprises a plurality of internal electric cables 68. The internal electric cables 68 are internal with respect to the control cabinet 14. Each internal electric cable 68 has been connected to a unique connection terminal 52 by stripping and pushing the internal electric cable 68 into the connection terminal 52. No tool is thus required for connecting the internal electric cables 68 to the connection terminals 52.

A customer can connect a control unit (not shown) to one of the internal electric cables 68 for controlling the end effector 20. Each shielding element 60 is connected to a shield (not denoted) of a unique internal electric cable 68 to improve signal integrity.

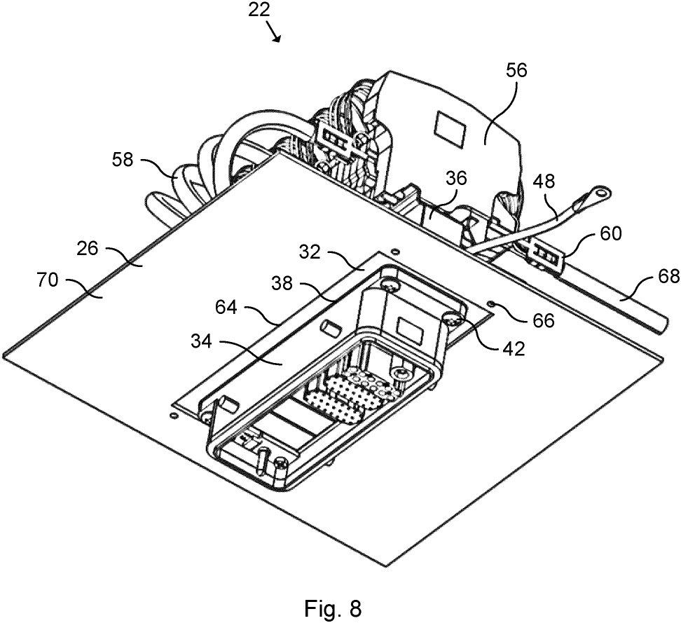

FIG. 8 schematically represents a perspective bottom view of the electric connection assembly 22 installed in the wall 26. In FIG. 8, the exterior side 70 of the wall 26 can be seen.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. An electric connection assembly for a control cabinet, the electric connection assembly comprising:
a base body having an opening structure;
an electric connector for connection to a plurality of external electric cables, the connector being connected to the base body and aligned with the opening structure; and
a support structure comprising a rail for supporting a plurality of electric connection terminals, the support structure being connected to the base body opposite to the connector.

2. The electric connection assembly according to claim 1, wherein the support structure comprises one or more legs distancing the rail from the opening structure, and wherein the one or more legs are connected to the base body.

3. The electric connection assembly according to claim 1, wherein the support structure comprises two legs wherein the rail is provided between the legs, and wherein the legs are connected to the base body on opposite sides of the opening structure.

4. The electric connection assembly according to claim 1, wherein the rail is a DIN rail.

5. The electric connection assembly according to claim 1, wherein the support structure is made from a single sheet of material.

6. The electric connection assembly according to claim 1, wherein the base body is a plate.

7. The electric connection assembly according to claim 1, wherein the connector is a heavy-duty connector.

8. The electric connection assembly according to claim 1, further comprising the plurality of connection terminals, each connection terminal being connected to the rail and being configured to be connected to an internal electric cable.

9. The electric connection assembly according to claim 8, further comprising one or more intermediate electric cables, each connected to the connector and to a unique connection terminal.

10. The electric connection assembly according to claim 8, further comprising a terminal block, and wherein the connection terminals are provided in the terminal block.

11. The electric connection assembly according to claim 8, wherein each connection terminal is a push-in terminal.

12. The electric connection assembly according to claim 1, further comprising a plurality of electrically conductive shielding elements, each shielding element being electrically connected, and each shielding element being connectable to a shield of an internal electric cable.

13. A control cabinet for an industrial robot, the control cabinet comprising an electric connection assembly including:
a base body having an opening structure;
an electric connector for connection to a plurality of external electric cables, the connector being connected to the base body and aligned with the opening structure; and
a support structure comprising a rail for supporting a plurality of electric connection terminals, the support structure being connected to the base body opposite to the connector.

14. The control cabinet according to claim 13, wherein the control cabinet comprises a wall having an interior side, an exterior side and a through hole, wherein the base body is connected to the interior side, and wherein the connector protrudes through the through hole.

15. A robot system comprising an industrial robot, a control cabinet comprising an electric connection assembly including:
a base body having an opening structure;
an electric connector for connection to a plurality of external electric cables, the connector being connected to the base body and aligned with the opening structure; and
a support structure comprising a rail for supporting a plurality of electric connection terminals, the support structure being connected to the base body opposite to the connector, and a plurality of external electric cables connected to the industrial robot and to the connector.

16. The electric connection assembly according to claim 2, wherein the support structure comprises two legs, wherein the rail is provided between the legs, and wherein the legs are connected to the base body on opposite sides of the opening structure.

17. The electric connection assembly according to claim 2, wherein the rail is a DIN rail.

18. The electric connection assembly according to claim 2, wherein the support structure is made from a single sheet of material.

19. The electric connection assembly according to claim 2, wherein the base body is a plate.
